(19) United States
(12) Patent Application Publication
(10) Pub. No.: US 2010/0301531 A1
(43) Pub. Date: Dec. 2, 2010

(54) ELASTIC SUSPENSION MEMBER OF PLASTIC MATERIAL AND OF THE SPRING OR BALL AND SOCKET TYPE OR THE LIKE FOR BED BASE, MATTRESS OR SEAT

(75) Inventors: Marc Delahousse, Angers (FR); Olivier Gregoire, Coutures (FR)

Correspondence Address: YOUNG & THOMPSON, 209 Madison Street, Suite 500, Alexandria, VA, 22314, US

(73) Assignee: DELAHOUSSE ET FILS, Vauchretien (FR)

(21) Appl. No.: 12/599,398

(22) PCT Filed: May 5, 2008
(86) PCT No.: PCT/FR08/50788

§ 371 Date: Nov. 9, 2009

(30) Foreign Application Priority Data
May 9, 2007 (FR) 0703315

(51) Int. Cl. F16F 3/087; A47C 23/04; A47C 19/02; A47C 7/34; F16F 1/36; F16F 1/18; F16F 1/26

(52) U.S. Cl. 267/165

(57) ABSTRACT

The invention relates to an elastic suspension member of the plastic material and of the spring or ball and socket type or the like, that comprises a base (2) and a head (3) between which is provided an elastic suspension member (4). The elastic member (1) comprises a central longitudinal suspension axis (A). According to the invention, the elastic suspension member (4) comprises three identical elastic structures (5, 6, 7) each including at least two rectilinear or substantially rectilinear juxtaposed arms (8) connected by pairs by a hinge (9) in order to define one or more suspension Vs each active in a suspension plane (P, P′, P″) perpendicular to said hinge (9). The suspension planes (P, P′, P″) of the three elastic structures (5, 6, 7) intersect each other at the axis of said longitudinal axis (A), and the suspension planes (P, P′, P″) are offset by pairs by an angle of about 120°.

The present invention relates to an elastic suspension member made of the plastic material and of the spring or ball-and-socket type or the like, for bed base, mattress or seat.

Very numerous alternatives of elastic suspension members made of plastic, used as springs within a mattress or seat structure, or as a ball-and-socket joint for slatted or multi-element bed bases, are known.

By way of information, a known structure for such suspension members, made up of an assembly of suspension Vs, is described in U.S. Pat. No. 2,433,012.

However, the current elastic members do not, for some of them, offer optimum suspension characteristics. Other ones have relatively complex structures, obtained for example by assembling several parts (base, suspension element, board . . . ), or of the single-piece type requiring complex, expensive and not very productive tools.

The object of the present invention is to remedy these drawbacks by proposing a new suspension structure, easy to produce by a moulding technique, and having interesting compressibility characteristics.

Conventionally, this elastic suspension member comprises a base and a head between which an elastic suspension element is interposed; it also comprises a central longitudinal suspension axis A.

According to the present invention, the elastic suspension element is made up of three identical or substantially identical elastic structures, each formed of at least two rectilinear or substantially rectilinear juxtaposed arms, connected together, by pairs, by a hinge in order to form one or more suspension Vs, each active in a suspension plane perpendicular to said hinge, said suspension planes of said three elastic structures intersecting each other at the longitudinal central axis A of said suspension member, and being offset, by pairs, by an angle of about 120°.

Preferably, the arms of the elastic structures are made up of flat blades each extending in a plane perpendicular to the associated suspension plane; these flat blades are connected together, by pairs, by a hinge which also extends perpendicular to said suspension plane.

According to another particularity, the suspension axis of the elastic structures are parallel to each other and parallel to the central longitudinal axis A of the suspension member, said suspension axis being positioned on the same circle centred to the central axis A, and separated, by pairs, by an angular sector of 120°.

According to a particularly interesting embodiment, the elastic structures of the suspension element each comprise at least three juxtaposed arms, and they are further advantageously connected together by at least one connecting member, in particular to favour the suspension member stability and thus to force said elastic structures to deform along their respective suspension axis.

The corresponding connecting member(s) are advantageously composed of three legs that extend radiantly from a common central part. The outer end of each of these legs is preferably connected to one of the “inner” hinges of one of the elastic structures.
Still preferably, all the “inner” hinges of the elastic structures are, at a same level, connected together by a connecting member.

The connecting member(s) are preferably made single-piece with the arms of the elastic structures.

According to a particular embodiment, the elastic member comprises a single connecting member positioned in a plane that extends approximately at equal distance from the base and the head.

According to another preferred embodiment, the different parts of the suspension member, i.e. head, base and suspension element, are made single-piece by moulding a thermoplastic elastomeric material.

The invention will be further illustrated, without being in any way limited, by the following description of a particular embodiment, given only by way of example and shown in the attached drawings, in which:

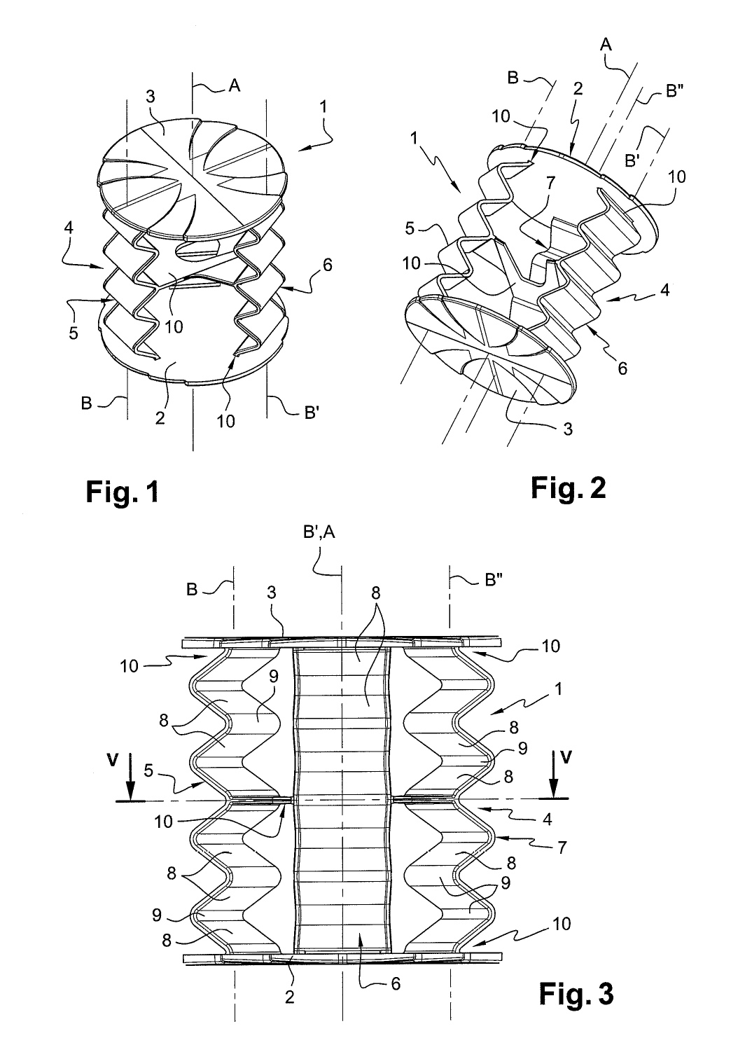

FIG. 1 is a perspective view of a possible embodiment of the elastic suspension member according to the invention;

FIG. 2 shows the elastic member of FIG. 1, herein also illustrated in perspective, viewed from another angle;

FIG. 3 is a front view of the elastic member illustrated in FIGS. 1 and 2;

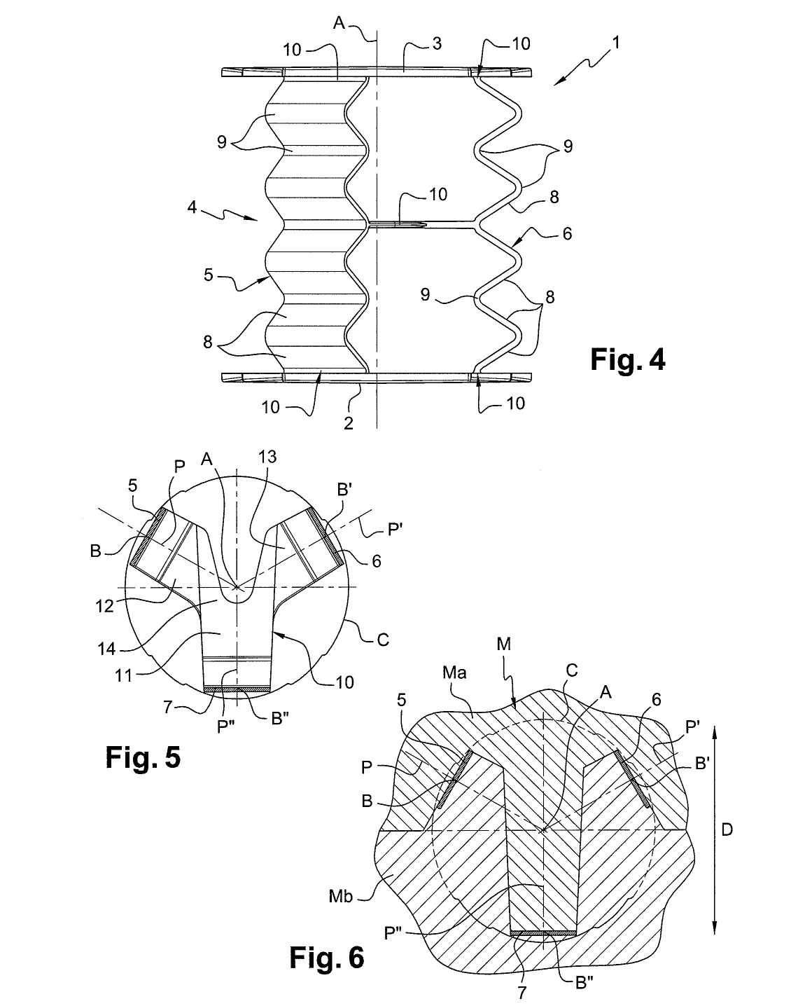

FIG. 4 is another front view of the same elastic member, herein illustrated from another angle;

FIG. 5 is a cross-sectional view, taken along the line V-V of FIG. 3;

FIG. 6 is a cross-sectional view schematically showing the mould for manufacturing the elastic member of FIGS. 1 to 5;

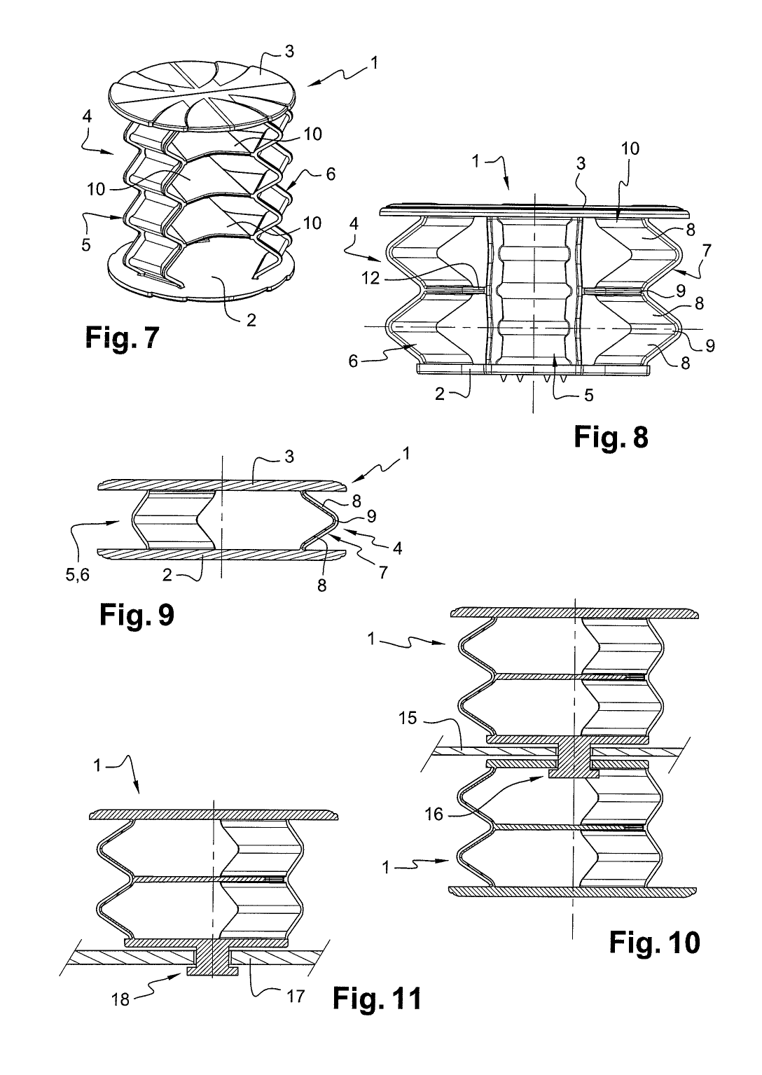

FIG. 7 is a perspective view of a first alternative embodiment of an elastic member according to the invention;

FIG. 8 is a face view of a second alternative embodiment of an elastic member according to the invention;

FIG. 9 is a schematic front view of a third alternative embodiment of an elastic member according to the invention;

FIG. 10 is a schematic front view of a fourth alternative embodiment of an elastic member according to the invention;

FIG. 11 is a schematic front view of a fifth alternative embodiment of an elastic member according to the invention.

As illustrated in FIGS. 1 to 5, the elastic member 1 is in the form of a spring made up of a base 2 and a head 3 between which an elastic suspension element 4 is interposed. This elastic member 1 comprises a central longitudinal axis A, corresponding to the compression/decompression axis of the elastic suspension element 4.

The elastic suspension element 4 is adapted to tend to separate the head 3 from the base 2 when these two elements have be brought closer to one another by compression, and to then tend to recover the stable position illustrated in the figures.

The suspension element 4 is made up of three identical elastic structures 5, 6 and 7, each formed of several rectilinear arms 8 (in this case, eight arms), connected to each other, by pairs, at one of their ends by an hinge joint 9, so as to form juxtaposed suspension Vs.

The arms 8 adjacent to the base 2 and the head 3 are connected to these latter by a hinge joint 10.
The arms 8 are oriented alternately in a direction and the other to provide the elastic structures 5, 6 and 7 with a compressible accordion-like structure.

Each of these elastic structures 5, 6 and 7 comprises a suspension axis, B, B′ and B″ respectively, that are all parallel to each other and also parallel to the longitudinal central axis A of the elastic member 1.

These three suspension axis B, B′, B″ are regularly distributed around a same circle C centred to the axis A (FIG. 5). Over this circle C, the different suspension axis B, B′, B″ are separated, by pairs, by an angular sector of 120° (or about)120°.

On the other hand, the elastic structures 5, 6 and 7 (and the suspension Vs that make them up) are active in suspension planes, P, P′, P″ respectively, that intersect each other at the central longitudinal axis A of the elastic member 1 (FIG. 5). The corresponding suspension planes, P, P′, P″, are planes that pass through the associated suspension axis B, B′, B″, and that are perpendicular to the axis corresponding to the hinge joints 9. These suspension planes P, P′, P″ are offset, by pairs, by an angle of 120° (or about)120°.

The arms 8 of the suspension Vs are in the form of flat blades that extend in a plane—perpendicular to the associated suspension planes P, P′, P″, and—tilted with respect to the plane passing through the base 2 or the head 3.

The arms 8 have all the same length and the same width.

The hinges 9 of the three suspension structures 5, 6 and 7 are located in successive planes parallel to each other, always at equal distance from the head 3 and from the base 2. Due to the general accordion-like configuration of the elastic structures 5, 6 and 7, one hinge 9 in two of said structures is positioned on the outer side of the spring member 1, and one hinge 9 in two thus extends inwardly, being located on the side of the central axis A.

The compressibility characteristics of the suspension member 1 are substantially linked to the work of the connecting hinges 9, 10, and possibly a little to the bending of the arms 8.

In FIGS. 1 to 5, the base 2 and head 3 elements are simple boards. Of course, they may take more complex forms, adapted to the function they are required to fulfil (simple planar bearing element, fastening to a framework, accommodation member for a slat or a suspension board . . . ). Theses base 2 and head 3 elements may also be equipped with any fastening means allowing several springs 1 to be mounted together.

On the other hand, the number of arms 8 of the suspension structures will be adapted according the required compressibility characteristics for the spring member 1 and according to the dimensional characteristics of the site to be equipped. Preferably, this number is between 2 and 10; still preferably, between 3 and 8.

This suspension member 1 is adapted and shaped so that it can be obtained single-piece, in a very simple manner, by moulding a thermoplastic elastomeric material.

The structure of the suspension member 1 (and in particular that of the elastic element 4) is adapted so that it can be drawn in a “natural” manner, by means of a two-part mould. For this purpose, the three elastic structures 5, 6 and 7 of the suspension element 4 extend at a distance from one another, and are separated from one another with respect to an axis passing through the suspension planes P, P′, P″, as can be seen in FIGS. 3 and 5.

FIG. 6 shows a possible embodiment of the mould M in two parts Ma and Mb, suitable for manufacturing the spring member 1 from an elastomeric plastic material. In FIG. 6, the drawing axis D is shown.

It is noted that this drawing axis D is parallel to the suspension plane (in this case, P″) of one of the elastic structures (in this case, 7).

Besides, as illustrated in FIGS. 1 to 4, the elastic member 1 advantageously comprises a member 10 that connects the three elastic structures 5, 6, 7. In this case, the connecting member 10 connects the elastic structures 5, 6, 7 at one of their opposite hinges 9 (and in particular one of their “inner” hinges, i.e. located on the side of the central axis A).

This connecting structure 10, shown in detail in FIG. 5, consists of a plane blade of material made up of three legs 11, 12, 13 extending radiantly from one common central region 14. This plane connecting blade 10 herein extends in the median plan of the elastic member 1, parallel or substantially parallel to the head 3 and the base 2.

The role of this connecting member 10 is to favour the stability of the elastic member 1 and to force the structures 5, 6, 7 to deform along their respective suspension axis B, B′, B″.
This connecting blade 10 is made single-piece with the rest of the structure.

It is understood that le number of connecting members 10 may be adapted as needed, especially according to the number of arms 8, as well as according to the required compressibility and stability characteristics.

FIGS. 7 to 11 illustrate different alternative embodiments of an elastic member 1 according to the invention.

For the purpose of simplification, in the different illustrated embodiments, the parts that are identical or similar to those of the embodiment of FIGS. 1 to 5 are denoted by the same reference numbers.

The alternative embodiment of FIG. 7 is very close to that illustrated in FIGS. 1 to 5. Herein, however, the suspension member 1 comprises three connecting members 10 in the form of blades of material, arranged parallel to one another. More particularly, all the “inner” hinges 9 of a same level of the elastic structures 5, 6, 7 are connected to a same connecting member 10.

In the embodiment of FIG. 8, the elastic structures 5, 6 and 7 are each made up of four arms 8.

Their one and single “inner” hinges 9 are connected together by a connecting member 10.
The head element 3 is in the form of a simple bearing board, whereas the base element 2 comprises fastening means adapted for the fastening to the desired support, for example a board or a sheet.

FIG. 9 illustrates a simplified embodiment of the suspension member 1, with three suspension structures 5, 6, 7, each made up of two arms 8 connected together by a single hinge 9.

FIG. 10 illustrates the fastening of two elastic members 1 according to the invention to a sheet of material 15, on either side of this sheet. The two elastic members 1 comprise suitable connecting means 16 (for example of the tenon/mortise type, arranged at their respective bases) for their attachment through an orifice formed in the sheet 15.

FIG. 11 illustrates the fastening of an elastic member 1 according to the invention to a rigid board 17, by means of an adapted connecting system 18 (advantageously removable), for example of the tenon/mortise type.

The elastic suspension member illustrated in the above-described figures consists in a spring member intended to be inserted within the structure of a mattress or a seat.

In alternative embodiments, the base and head of this suspension member can be adapted to form a suspension ball-and-socket joint for bed-base slat(s), a suspension structure for the board of a multi-element bed base, or a system for varying firmness for bed-base slat(s).

The invention allows a stable and well balanced suspension assembly to be obtained.

1. An elastic suspension member made of plastic, and of the spring or ball-and-socket type or the like, for bed base, mattress or seat, said elastic member (1) comprising a base (2) and a head (3) between which an elastic suspension member (4) is interposed, and said elastic member (1) comprising a central longitudinal suspension axis (A), characterized in that said elastic suspension member (4) is made up of three identical or substantially identical elastic structures (5, 6, 7), each formed of at least two rectilinear or substantially rectilinear juxtaposed arms (8), connected together, by pairs, by a hinge (9) in order to form one or more suspension Vs, each active in a suspension plane (P, P′, P″) perpendicular to said hinge (9), said suspension planes (P, P′, P″) of said three elastic structures (5, 6 and 7) intersecting each other at said longitudinal suspension axis (A), and said suspension planes (P, P′, P″) being offset, by pairs, by an angle of about 120°.

2. An elastic suspension member according to claim 1, characterized in that the arms (8) of the elastic structures (5, 6, 7) are made up of flat blades each extending in a plane perpendicular to the associated suspension plane (P, P′, P″), and connected together, by pairs, by a hinge (9) which also extends perpendicular to said suspension planes (P, P′, P″).

3. An elastic suspension member according to claim 1, characterized in that the suspension axis (B, B′, B″) of the elastic structures (5, 6, 7) are parallel to each other and parallel to the central longitudinal axis (A) of said suspension member (1), said suspension axis (B, B′, B″) being positioned on the same circle (C) centred to said central axis (A), separated, by pairs, by an angular sector of 120°.

4. An elastic suspension member according to claim 1, characterized in that the elastic structures (5, 6, 7) of the suspension element (4) each comprise at least three juxtaposed arms (8), and are connected together by at least one connecting member (10), in particular to favour the stability thereof and thus to force said elastic structures (5, 6, 7) to deform along their respective suspension axis (B, B′, B″).

5. An elastic suspension member according to claim 4, characterized in that it comprises at least one connecting member (10) in the form of flat blade which is composed of three legs (11, 12, 13) that extend radiantly from a common central part (14).

6. An elastic suspension member according to claim 5, characterized in that the outer end of each of the legs (11, 12, 13) of the connecting member (10) is connected to one of the “inner” hinges (9) of one of the elastic structures (5, 6, 7).

7. An elastic suspension member according to claim 6, characterized in that all the “inner” hinges (9) of the elastic structures (5, 6, 7) are, at a same level, connected together by a connecting member (10).

8. An elastic suspension member according to claim 5, characterized in that it comprises a single connecting member (10) positioned in a plane that extends approximately at equal distance from the head (3) and from the base (2).

9. An elastic suspension member according to claim 5, characterized in that the connecting member(s) (10) are made single-piece with the arms (8) of the elastic structures (5, 6, 7).

10. An elastic suspension member according to claim 1, characterized in that the different parts thereof, i.e. head (3), base (2) and suspension element (4), are made single-piece by moulding a thermoplastic elastomeric material.

11. An elastic suspension member according to claim 2, characterized in that the suspension axis (B, B′, B″) of the elastic structures (5, 6, 7) are parallel to each other and parallel to the central longitudinal axis (A) of said suspension member (1), said suspension axis (B, B′, B″) being positioned on the same circle (C) centred to said central axis (A), separated, by pairs, by an angular sector of 120°.

12. An elastic suspension member according to claim 2, characterized in that the elastic structures (5, 6, 7) of the suspension element (4) each comprise at least three juxtaposed arms (8), and are connected together by at least one connecting member (10), in particular to favour the stability thereof and thus to force said elastic structures (5, 6, 7) to deform along their respective suspension axis (B, B′, B″).

13. An elastic suspension member according to claim 3, characterized in that the elastic structures (5, 6, 7) of the suspension element (4) each comprise at least three juxtaposed arms (8), and are connected together by at least one connecting member (10), in particular to favour the stability thereof and thus to force said elastic structures (5, 6, 7) to deform along their respective suspension axis (B, B′, B″).

14. An elastic suspension member according to claim 2, characterized in that the suspension axis (B, B′, B″) of the elastic structures (5, 6, 7) are parallel to each other and parallel to the central longitudinal axis (A) of said suspension member (1), said suspension axis (B, B′, B″) being positioned on the same circle (C) centred to said central axis (A), separated, by pairs, by an angular sector of 120°.

15. An elastic suspension member according to claim 6, characterized in that it comprises a single connecting member (10) positioned in a plane that extends approximately at equal distance from the head (3) and from the base (2).

16. An elastic suspension member according to claim 6, characterized in that the connecting member(s) (10) are made single-piece with the arms (8) of the elastic structures (5, 6, 7).

17. An elastic suspension member according to claim 7, characterized in that the connecting member(s) (10) are made single-piece with the arms (8) of the elastic structures (5, 6, 7).

18. An elastic suspension member according to claim 8, characterized in that the connecting member(s) (10) are made single-piece with the arms (8) of the elastic structures (5, 6, 7).
